(19) United States
(12) Patent Application Publication
(10) Pub. No.: US 2026/0101885 A1
(43) Pub. Date: Apr. 16, 2026

(54) NEGATIVE PRESSURE VENTILATION ASSISTED EX VIVO LUNG PRESERVATION SYSTEM

(71) Applicants: BioMedInnovations, LLC, Winston-Salem, NC (US); Duke University, Durham, NC (US)

(72) Inventors: Tony Arndt, Denver, NC (US); Charles Herman Aardema, Jr., Bassett, VA (US); Varun Lingaiah Kopparthy, Raleigh, NC (US); Carrie Bordeaux DiMarzio, Denver, NC (US); Kentaro Nakata, Durham, NC (US); Andrew Barbas, Chapel Hill, NC (US); Matthew G. Hartwig, Durham, NC (US)

(21) Appl. No.: 19/358,730

(22) Filed: Oct. 15, 2025

Related U.S. Application Data
(60) Provisional application No. 63/707,406, filed on Oct. 15, 2024.

(51) Int. Cl. A01N 1/126; A01N 1/143; A01N 1/165

(52) U.S. Cl. CPC A01N 1/126; A01N 1/143; A01N 1/165

(57) ABSTRACT

An apparatus for perfusing a lung includes: an enclosure configured to provide physical protection to a lung; and a fluid flow loop extending from an outlet connection of the enclosure to an inlet connection of the enclosure, the fluid flow loop including a pump, an oxygenator, and a waveform generator; at least one sensor operable to sense a parameter of a perfusate flowing within the fluid flow loop and generate a signal representative thereof, a negative pressure ventilation apparatus configured to force respiration of the lung through cyclic changes of gas pressure between the lung and the enclosure; and a control and monitoring unit configured to receive the signal from the at least one sensor and adjust the parameter in response thereto.

### BACKGROUND OF THE INVENTION

This invention relates generally to organ support processes, and more particularly to methods and apparatus for carrying out the preservation of the lung.

Lung transplantation remains the only long-term treatment for patients suffering from end-stage respiratory failure. However, transplanted lungs still suffer the lowest graft survival rates among commonly transplanted solid organs. Additionally, despite more than 4,000 patients on waiting lists and a waitlist mortality rate of 17.6 deaths per 100 patient-years in 2021, fewer than 25% of available donor grafts are ultimately utilized due to questionable organ viability. To address this challenge, ex situ lung perfusion, also known as ex vivo lung perfusion (EVLP) has become a focus of development as a means to evaluate and potentially recondition otherwise unusable organs. EVLP also represents a possible platform through which all lungs could be modified for improved outcomes.

However, in many organ perfusion processes the flow pressure characteristics of the process fluid are much different than that provided by a patient's heart.

Accordingly, there remains a need specifically for the preservation of lungs, which have unique characteristics compared to other internal organs.

### BRIEF SUMMARY OF THE INVENTION

This need is addressed by an apparatus which is operable to perfuse oxygenated and deoxygenated fluid through a lung while maintaining negative pressure ventilation.

### BRIEF DESCRIPTION OF THE DRAWINGS

The invention may be best understood by reference to the following description taken in conjunction with the accompanying drawing figures in which:

FIG. 1 is a schematic view of an organ support apparatus constructed according to an aspect of the present invention;

FIG. 2 is a schematic view of a pressure waveform generator or pulse generator of the organ support apparatus of FIG. 1;

FIG. 3 is a schematic graph of a flow characteristic of the apparatus in operation;

FIG. 4 is a schematic view of a negative pressure ventilation circuit of the apparatus of FIG. 1, using ambient air for respiration;

FIG. 5 is a schematic view of a negative pressure ventilation circuit of the apparatus of FIG. 1, using positive pressure air for respiration;

FIG. 6A is a portion of a software control flowchart for operation of a negative pressure ventilation apparatus;

FIG. 6B is a portion of a software control flowchart for operation of a negative pressure ventilation apparatus;

FIG. 7 is a set of photographs of three sets of lungs perfused for a period of 24 hours, using the methods described herein;

FIG. 8 is a chart of airflow through a set of perfused lungs, over a period of 24 hours;

FIG. 9 is a chart of mean PA pressure in a set of perfused lungs, over a period of 24 hours;

FIG. 10 is a chart of a parameter called CDYN of a set of perfused lungs, over a period of 24 hours. This is the measure of lung elasticity and indicative of general tissue integrity;

FIG. 11 is a chart of PF ratio for a set of perfused lungs, over a period of 24 hours;

FIG. 12 is a chart of pH in a set of perfused lungs, over a period of 24 hours;

FIG. 13 is a chart of sodium levels in a set of perfused lungs, over a period of 24 hours;

FIG. 14 is a chart of potassium levels in a set of perfused lungs, over a period of 24 hours;

FIG. 15 is a chart of lactate levels in a set of perfused lungs, over a period of 24 hours;

FIG. 16 is a schematic diagram of a organ support apparatus configured for dual perfusion of lungs;

FIG. 17 is a chart of total flow in a set of perfused lungs, using dual perfusion;

FIG. 18 is a chart of PVR in a set of perfused lungs, using dual perfusion;

FIG. 19 is a chart of P/F ratio in a set of perfused lungs, using dual perfusion;

FIG. 20 is a chart of Cdyn in a set of perfused lungs, using dual perfusion;

FIG. 21 is a photograph of IHC staining in a set of perfused lungs, using dual perfusion;

FIG. 22 is a chart of % DAB positive area in a set of perfused lungs, using dual perfusion;

FIG. 23 is a chart of % DAB positive area in a set of perfused lungs, using dual perfusion; and

FIG. 24 is a chart of HIF1α in a set of perfused lungs, using dual perfusion.

### DETAILED DESCRIPTION OF THE INVENTION

This description of exemplary embodiments of the invention may refer to the following abbreviations which are relevant to mechanical ventilation:

CPAP: Continuous positive airway pressure. Constant pressure maintained at the airway opening throughout the breathing cycle. CPAP refers to PEEP during spontaneous breathing.

PEEP: Positive end expiratory pressure. Positive pressure is held in the lungs during the exhalation phase of the mechanical breath.

FIO2: Fraction of inspired oxygen. The percentage of oxygen delivered (Ranges from 21%-100%).

PIP: Peak inspiratory pressure. Pressure recorded at end inspiration. PIP is dependent on volume or pressure delivered and airway resistance.

RR: Respiratory rate (Breaths per Minute, BPM). Number of preset mechanical breaths the patient will receive per minute.

VTT: Tidal volume. The volume of gas inhaled or exhaled during a breath.

VE: Minute ventilation. The average volume of gas entering or leaving the lungs per minute. Calculated by tidal volume×respiratory rate (VE=VTT×RR).

Paw: Mean airway pressure. Mean Airway Pressure (Paw) defines the mean pressure applied during positive-pressure mechanical ventilation and correlates with alveolar ventilation, arterial oxygenation, and hemodynamic performance. Paw is determined by PIP, the fraction of time devoted to the inspiratory phase (Ti/Ttot, where Ttot is total respiratory cycle time), and PEEP. Paw=((Inspiratory Time×Frequency)/60)×(PIP−PEEP)+PEEP

Pplat: Plateau pressure. The static trans alveolar pressure at end of inspiration during an inspiratory hold for an assisted breath.

I-Time: Inspiratory Time. The period from the start of inspiratory flow to the start of expiratory flow.

E-Time: Expiratory Time. The period from the start of expiratory flow to the start of inspiratory flow.

I:E Ratio: Inspiration to expiration ratio. The time constant determined by total respiratory rate and inspiratory time.

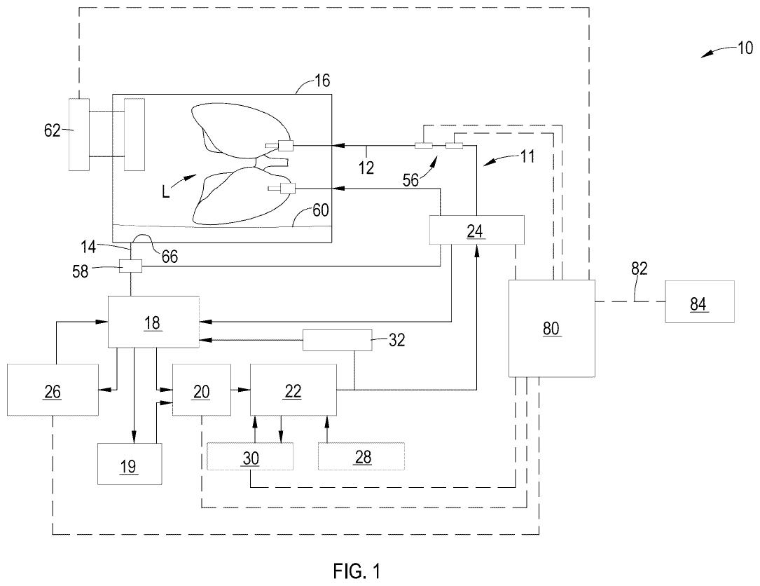

Now, referring to the drawings wherein identical reference numerals denote the same elements throughout the various views, FIG. 1 depicts an exemplary lung preservation apparatus 10, suitable for protecting a lung (or pair of lungs, as shown) and perfusing a fluid through the lungs. The apparatus 10 comprises a fluid circuit or loop 11 defined by a suitable conduit such as plastic tubing. The apparatus 10 is connected to a pair of lungs to be supported, depicted generally at “L”, by an inlet line 12 and an outlet line 14. The lungs L are contained in an enclosure 16.

The basic elements of the apparatus 10 include, in sequential fluid flow order, a fluid reservoir 18, a circulation pump 20, a gas exchange membrane 22, a fluid waveform generator 24 (alternatively referred to as a pulse generator), and the enclosure 16.

The apparatus 10 may include a dialysis unit 26 for filtering endogenous or exogenous material from the process fluid. In this example, the unit 26 is coupled to the reservoir 18 in a separate loop. A separate filter cassette 19 may be coupled to the reservoir 18 to remove toxins or leucocytes.

The circulation pump 20 may be any type of pump which can provide the required flow rates and pressures and is hygienic. The process fluid may be blood containing cells, plasma, and expanders, or other therapeutic fluids containing complex molecules. Examples of process fluids that may be used in different processes include aqueous organ preservatives such as “AMES' solution” and “Modified AMES' solution”, “University of Wisconsin solution”, “Belzer's solution”, “h\Histidine, tryptophan, and ketoglutarate (HTK)”, whole blood, plasma, serum, crystalloid and non-crystalloid expanders, and oxygen-carrying molecules. In addition, for active oxygenation, polymerized hemoglobin products such as HBOC-201, and nanoparticle-based emulsions can be added to the preservative solutions. Preferably the circulation pump 20 is a type which does not tend to damage these fluid components. Examples of suitable pumps include peristaltic and centrifugal types.

The gas exchange membrane 22 is of a known type which is configured to introduce oxygen into the fluid stream from an external source. The gas exchange membrane 22 is coupled to a source of oxygen, such as the illustrated tank 28, which may contain, for example, gaseous oxygen or a gas mixture like carbogen.

A heat exchanger 30 is operable to heat or cool the process fluid to a desired temperature. In the illustrated example, it is connected in a separate loop with the oxygenator 22. Alternatively, it could be positioned inline in the fluid flow loop.

A sampling port 32 is provided downstream of the gas exchange membrane 22, and drains back to the reservoir 18. The sampling port 32 allows for convenient access to perfusate samples and facilitates the administration of necessary interventions or medications.

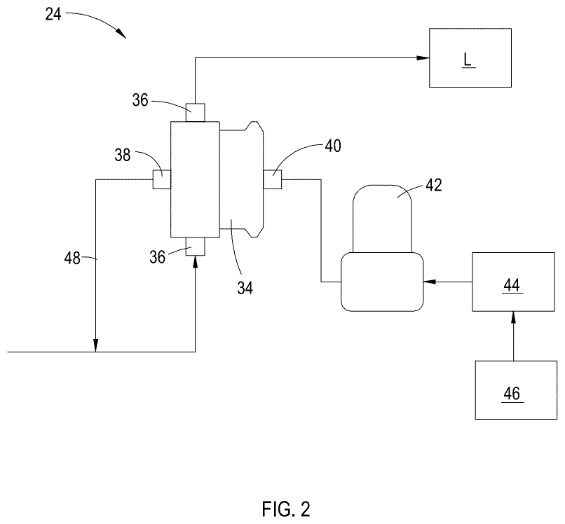

The waveform generator 24 is effective to receive process fluid from the fluid circuit and reduce the pressure to a suitable value for the lung L, for example about 1 to about 180 mm Hg and to apply a pressure profile thereto, so that the lung L receives a pulsating flow which mimics the flow characteristics of a patient's heart. In the illustrated example, shown in FIG. 2, the waveform generator 24 comprises a diaphragm-type pressure regulator 34 having a pair of process ports 36 connected to the fluid circuit, a bypass port 38 connected to a point upstream of the waveform generator 24, and a reference port 40 which is connected to an electropneumatic (E/P) transducer 42 of a known type. Suitable waveform generators of this type are commercially available. The E/P transducer 42 is in turn connected to a programmable electronic controller 44 or computer through an input/output (I/O) card 46.

Referring again to FIG. 1, the waveform generator 24, which is described in detail below, receives blood flow from the pump 14 and applies a cyclic pressure pulse thereto, as commanded by the controller 44, so that the lung L receives a pulsating flow which mimics the flow characteristics of the patient's heart. An exhaust line 48 routes exhaust fluid from the waveform generator 24 back to an upstream portion of the apparatus, for the example the inlet of the circulation pump 20.

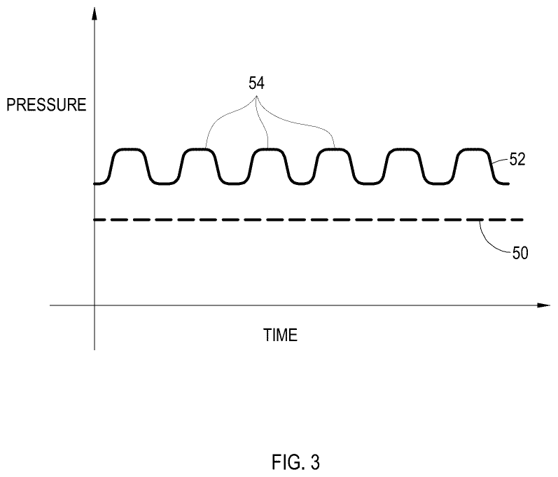

FIG. 3 illustrates an example of the flow characteristics that can be obtained. The dashed line 50 represents the essentially constant pressure output of the circulation pump 20, while the solid line 52 represents the total pressure after the fluid passes through the waveform generator 24. Appropriate feedback signals are provided to the controller 44 representative of the output of the apparatus 10. In the illustrated example, the flow has a pulsating pressure with peaks 54 occurring at regular intervals. A quasi-square-wave flow characteristic is shown; however, by careful control programming, almost any wave shape desired can be obtained. This allows the apparatus 10 to closely emulate the flow characteristics of the patient's heart or to generate specific preferred waveforms as determined by the physician or technician involved in a particular procedure. It is thought that this will maximize the “shelf life” of the lung L.

The apparatus 10 may include monitoring and feedback systems. These may be used to continuously assess parameters such as temperature, pH, and oxygen levels. These systems provide real-time data to ensure optimal preservation conditions and allow for timely intervention if parameters deviate from the desired range. In the illustrated example, this function may be implemented using one or more sensor arrays.

An upstream sensor array 56 may be disposed between the waveform generator 24 and the enclosure 16. It may include one or more sensors for evaluating the condition of the process fluid in the fluid circuit, such as flow rate, pressure, temperature, bubble detection, oxygenation levels, gas and/or chemical composition, pH, and/or CO2 levels. Known types of transducers and sensors are utilized to generate signals representative of each measured parameter.

The oxygenation capacity is a critical viability measure for the lung. The sensors positioned in-line in the arterial and venous flow will continuously measure the real-time oxygen data. The control unit will compute the oxygenation capacity.

A downstream sensor array 58 may be disposed between the enclosure 16 and the reservoir 18. It may include one or more sensors for evaluating the condition of the process fluid in the fluid circuit, such as flow rate, pressure, temperature, bubble detection, oxygenation levels, gas and/or chemical composition, pH, and/or CO2 levels. Known types of transducers and sensors are utilized to generate signals representative of each measured parameter.

Comparing information from the upstream and downstream sensor arrays 56, 58 facilitates precise monitoring of tissue viability. For example, the differential oxygenation level information from the two arrays may permit measuring the oxygen consumption of the tissue within the preserved lung L.

Optionally, the perfusion loop may include at least one spectroscopic flow cell (such as a flow-through cell or flow-through cuvette), not shown, designed for recording spectra through various spectroscopic methods, including UV-VIS spectroscopy, fluorescence spectroscopy, Raman spectroscopy, circular dichroism spectroscopy, and (near) infrared spectroscopy. This flow cell allows for the detection and analysis of at least one compound or molecule present in the perfusate. Integrated within the perfusion loop (which may comprise a tube set or disposable set), the perfusate flows through the spectroscopic flow cell. In a preferred embodiment, fluoroscopic measurements enable the identification of the presence or absence of the target molecule within the perfusate. The spectroscopic flow cell can be positioned at any suitable location within the loop assembly. The spectroscopic flow cell can measure molecules such as flavin mononucleotide (FMN), NADH, ADH, and succinate.

The enclosure 16 (see FIG. 1) provides physical protection to the lungs L. The organ enclosure may be sized and configured to house a pair of lungs. It may be constructed from sterilizable transparent medical-grade polymer, and is provided with connections between the lungs L and the inlet and outlet lines 12 and 14 respectively. It may include an air filtration system (not shown) to prevent contamination.

In the illustrated example, the enclosure 16 includes a flexible hammock 60 that supports the lungs L while evenly distributing the pressure. The hammock 60 or the enclosure itself may include an integrated weight monitoring system to assess the weight of the lungs during preservation, providing valuable data for preservation quality assessment. For example, the hammock 60 may include a weight scale or a strain gauge to sense the weight of the lungs L.

The enclosure 16 incorporates a temperature control mechanism to regulate the temperature within. Maintaining the appropriate temperature is essential for preserving tissue viability and preventing cellular degradation. In the illustrated example, a small-scale HVAC unit 62 such as a conventional heat pump is shown for this function.

The enclosure 16 includes means for coupling one or both of the inlet line 12 and the outlet line 14 in fluid flow communication with the lung L. In the illustrated example, the inlet line 12 is coupled to the lung L using a cannula 64. The outlet line is coupled to a drain port 66 in the enclosure 16 and collects fluid which has been perfused through the lung L.

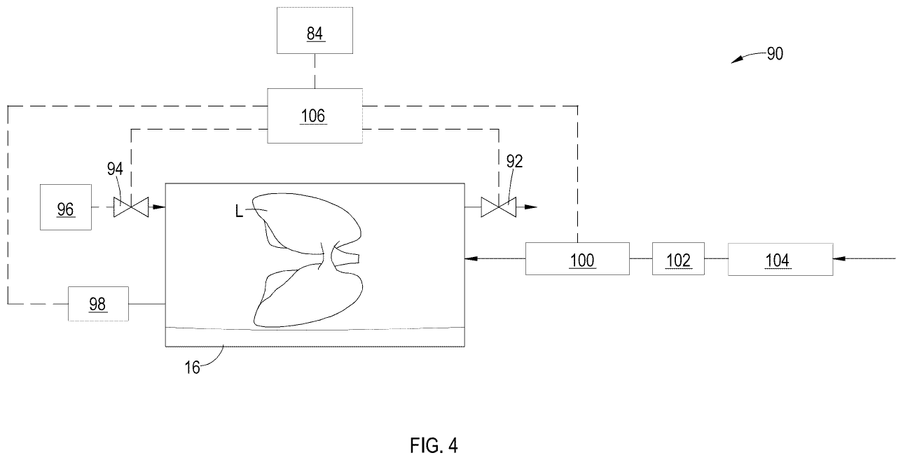

FIG. 4 illustrates a negative pressure ventilation (“NPV”) apparatus 90 which may be incorporated into the preservation apparatus 10 described above. The NPV apparatus 90 is operable to force respiration of the lungs L through cyclic changes of the pressure between the lungs L and the enclosure 16. The NPV apparatus 90 may be used in conjunction with the organ support apparatus to provide mechanical respiration while the lungs L are perfused.

An exhalation valve 92 is coupled to the enclosure 16. When open, it communicates with the ambient atmosphere. The exhalation valve 92 is remotely operable, for example it may be solenoid-operated.

An inhalation valve 94 is coupled to the enclosure 16. When open, it communicates with a vacuum pump 96. The inhalation valve 94 is remotely operable, for example it may be solenoid-operated.

A chamber pressure sensor 98 is provided.

A flow sensor 100 is provided, coupled to the trachea of the lungs L. Upstream of the flow sensor 100 are a filter (e.g. HEPA filter) 102 and a humidifier 104.

A ventilation controller 106 is provided for the NPV apparatus. The ventilation controller 106 includes one or more processors and may be a general-purpose microcomputer of a known type, such as a PC-based computer, or may be a custom processor, or may incorporate one or more programmable logic controllers (PLC). The ventilation controller 106 is operably connected to the individual functional components of the NPV circuit in order to receive data and/or transmit commands to each component. In particular, the ventilation controller 106 is operable to selectively open and close the inhalation and exhalation valves 94, 92 while the vacuum pump 96 is operating in order to force respiration of the lungs L. This function is described in more detail below.

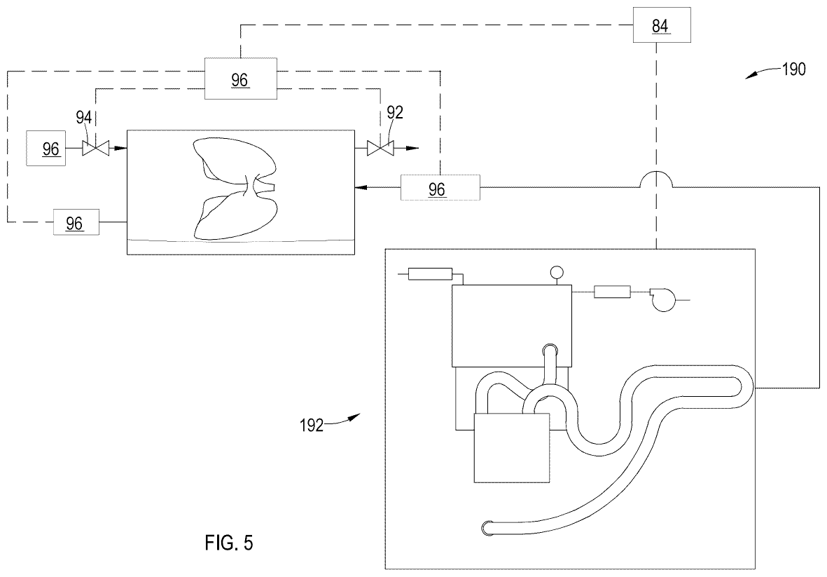

FIG. 5 illustrates an alternative configuration of an NPV apparatus 190. This configuration may be identical to the NPV apparatus 90 described above, with the difference that it includes a positive pressure apparatus 192 coupled to the trachea of the lungs L. The positive pressure apparatus 192 is operable to supply room air or a mixture of gases at a selected pressure. The positive pressure apparatus 192 may include means for filtering and humidification in the air or gas mixture.

A control and monitoring unit 80 is provided for the apparatus 10. The control and monitoring unit 80 includes one or more processors and may be a general-purpose microcomputer of a known type, such as a PC-based computer, or may be a custom processor, or may incorporate one or more programmable logic controllers (PLC). The control and monitoring unit 80 is operably connected to the individual functional components of the apparatus 10 in order to receive data and/or transmit commands to each component. For example, the control and monitoring unit 80 receives data about the process fluid condition from the sensor arrays 56, 58. It transmits pressure waveform commands to the waveform generator 24 to maintain a desired pressure waveform entering the lung L. The control and monitoring unit 80 may communicate directly with the functional components of the apparatus 10, or through intermediate devices such as the controller 44 described above. The data connections between the control and monitoring unit 80 and the individual components may be through wired or wireless channels. The control and monitoring unit 80 may be used for feedback control of the components in the apparatus 10 based on one or more inputs. Furthermore, pressure, flow, and/or temperature data from the various sensors may be used to adjust or “tune” the operating parameters of the apparatus 10.

In one configuration, the control and monitoring unit 80 may interface with the NPV controller 106. In an alternative configuration, the control and monitoring unit 80 may have the functions of the NPV controller 106 integrated therein, eliminating the need for a separate NPV controller 106.

The apparatus 10 may be provided with a data network connection 82 coupled to the control and monitoring unit 80. The purpose of the data network connection 82 is to bidirectionally exchange telemetry data with a remote computer 84. This may be used to monitor the performance of the apparatus 10 and/or to transmit commands to the apparatus 10 remotely. The data connection between the control and monitoring unit 80 and the remote computer 84 may be wired or wireless.

With appropriate programming, the control and monitoring unit 80 may be automatically pressure regulating for different tissue masses, thermal conditions that influence vascular elasticity, variable perfusate flow restrictions at the organ level, and variable fluid characteristics (e.g. viscosity, entrained shear sensitive solids, etc.), while precisely maintaining the process fluid flow between narrowly defined systolic and diastolic pressure set points. This will virtually eliminate the potential for permanent capillary damage due to over pressurization of organ vasculature.

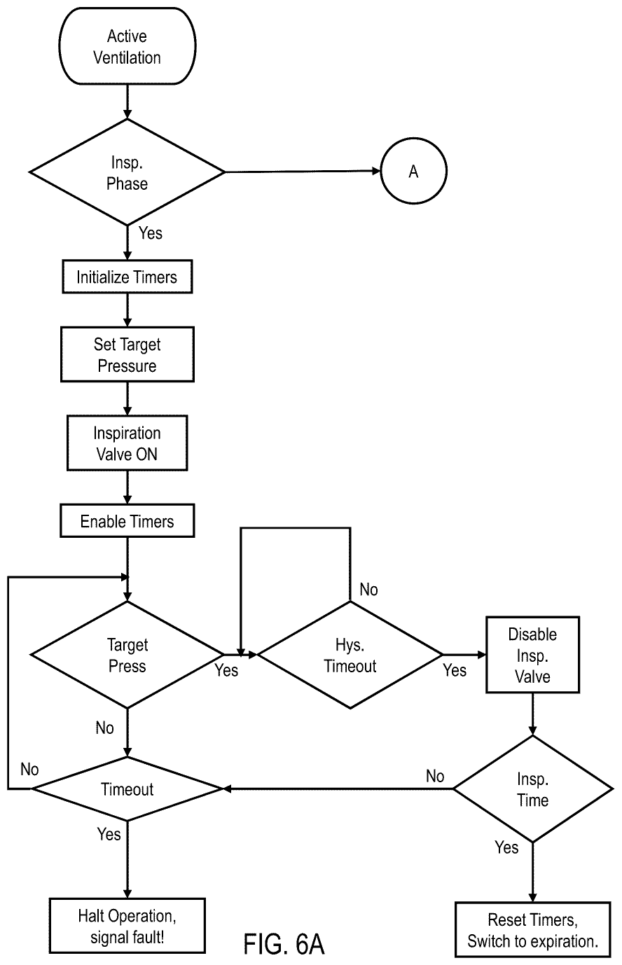

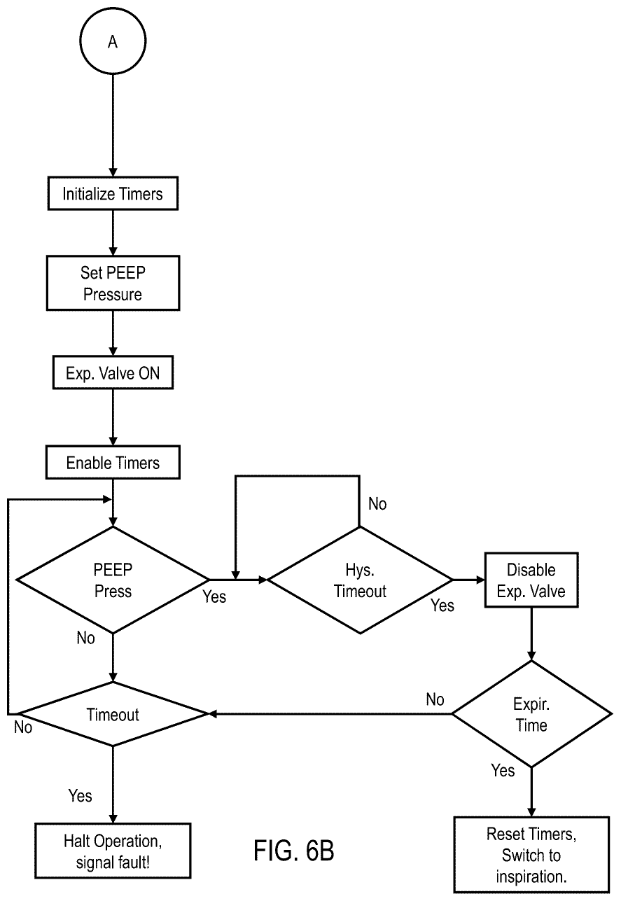

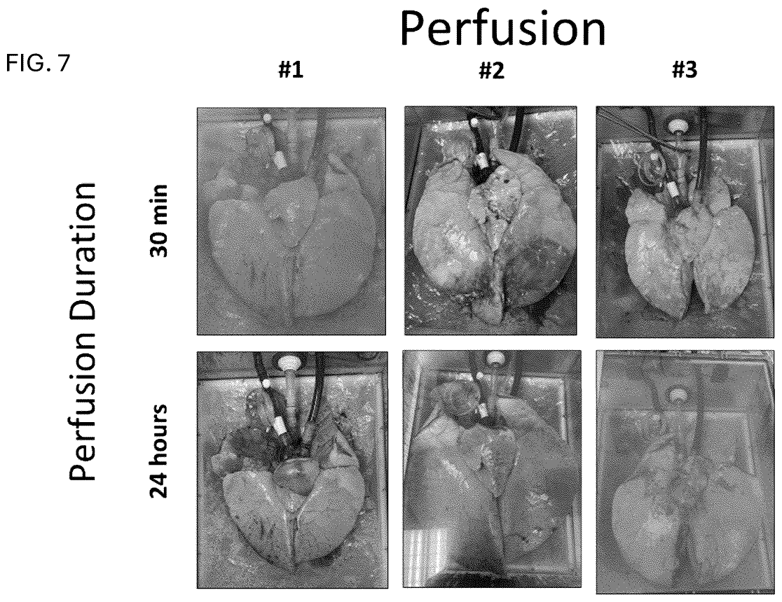

An example of operation of the apparatus 10 is as follows. (A flowchart of NPV controller software operation is shown in FIGS. 6A and 6B).

To start perfusion of the lungs, they are placed in the enclosure 16, vascular connections are made, and the trachea is connected to the airtight “bulkhead” fitting in the wall of the enclosure 16 (allowing airflow from the inside of the lungs to the room air exterior to the enclosure 16). Alternatively, if positive pressure ventilation is used, the trachea is coupled to the positive pressure apparatus 192 shown in FIG. 5.

Over a transition period, such as one hour, the temperature and vascular pressure are incrementally increased to achieve near-normal physiological values that will be maintained for the duration of the perfusion.

This transition period has no active ventilation of the lungs (the trachea is still clamped to maintain static pressure).

In preparation for the ventilation stage, the starting parameters for ventilation are entered into the NPV controller (PIP, PEEP, I:E ratio, and Breaths per min (BPM)).

At the start of ventilation, the tracheal clamp is removed, the enclosure is closed and clamped to maintain an airtight seal, and the enclosure with tubing and components is sealed from the room environment.

The NPV is turned on with inspiration as the starting action. Based on the settings entered to the NPV controller, the ventilation cycle continues.

Manual or automatic PID adjustment can be performed on the valves located near the solenoid controls, to regulate the inspiration and expiration rates.

If the lung inspiration is fully achieved before the programmed total inspiration time (calculated from the BPM and I:E ratio), the valve can be closed until the inspiration time matches the programmed time and vice-versa.

Expiration can be modulated identically to inspiration. At this point, the NPV system will run without intervention until a change is called for.

In addition, a challenge mode can be activated. This simulates a high oxygen demand scenario. New values are entered to the NPV controller 106 to begin this new stage. New values for PIP, PEEP, BPM, and I:E ratio is entered into the NPV controller 106. Note: not all settings may be changed, from one to all four are possible. Ventilation is then reinitiated.

Tidal volume is measured via the chamber flow sensor 100. This sensor monitors the inspiration flow.

### Example 1

An apparatus constructed as described above was used to perfuse porcine lungs.

The perfusate composition was an albumin-based perfusate mixed with oxygen carriers such as RBCs and including metabolites, and nutrients for lung preservation.

The following operational parameters were used:

| Parameter | Specifications |
|---|---|
| Ventilation | NPV |
| | Starting: 8 BPM, 14 PIP, 5 PEEP |
| Gas | 8% CO2/6% O2/balance N2 (3 L/min) |
| Vein | Cannulated (venous flow bypasses and |
| | connected to the reservoir) |
| Target | Flow control |
| pressure/flow | Cardiac Output to 30% |
| Temperature | 37° C. |

The lungs were supported by TPN 50 ml infusion for 24 hours, using an albumin-based perfusate mixed with oxygen carriers such as RBCs and including metabolites, and nutrients for lung preservation.

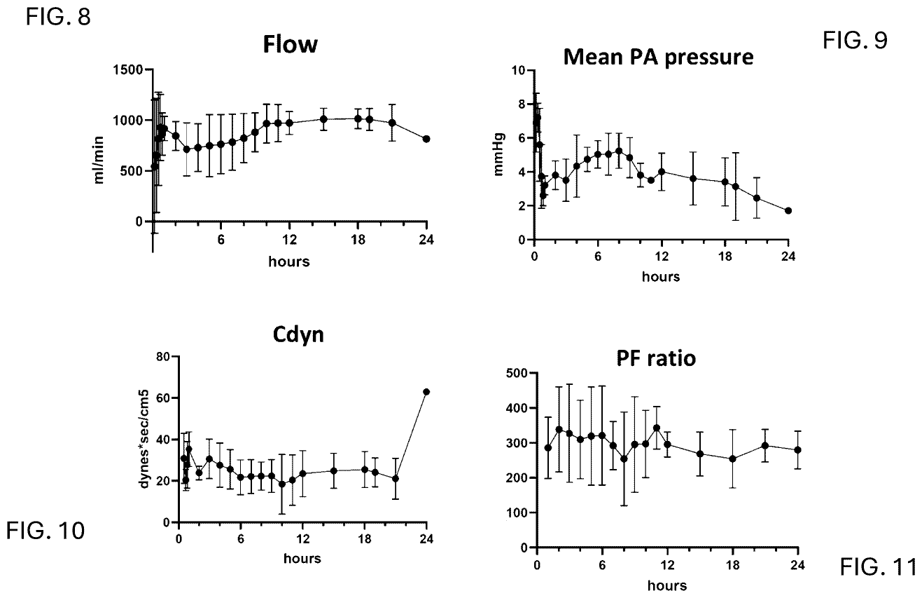

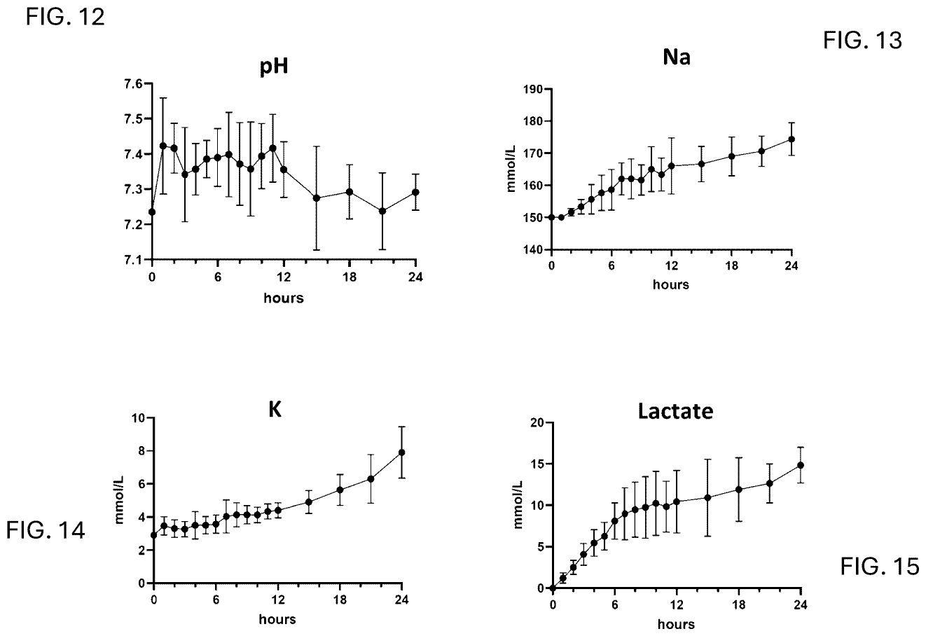

Viability of the lungs was maintained for a period of 24 hours. Measured ventilation data and chemical assay data for the test is shown in FIGS. 8-15.

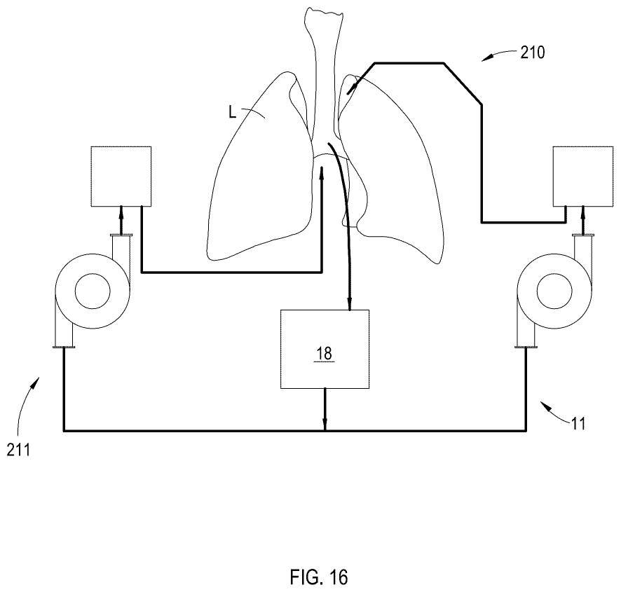

With modification, the apparatus 10 is also suitable for dual perfusion of the lungs. In dual perfusion, the lungs are perfused with fluid supplied to the pulmonary artery (PA) and the bronchial artery (BA). FIG. 16 illustrates a modified apparatus 210. This may be identical to apparatus 10 except that a second fluid loop 211 is provided for the bronchial artery. The second fluid loop may be configured similarly to the first fluid loop 11 described above and may be controlled by the control and monitoring unit 80.

### Example 2

The modified apparatus was used to perfuse porcine lungs, using dual perfusion.

Perfusate was composed of 1 L a proprietary albumin-based solution and 750 ml washed red blood cells (RBCs) purified from whole blood using a Cell Saver 5+ (Haemonetics Inc, Boston, MA). Perfusate was supplemented with the following: 8.4% NaHCO₃, 10% Calcium gluconate, methylprednisolone, tazobactam/piperacillin, voriconazole, heparin 10,000 U, multivitamin, and milrinone.

After air was purged from the circuit and perfusate was warmed to 24° C., the lungs were placed in the modified apparatus 210 described above. Using the first fluid loop 11, a flow was directed through the PA cannula. The PA loop was deoxygenated with a standard preservation gas mixture (CO2 8%, O2 6%, N2 86%).

An additional cannula was inserted into the distal Ao to perfuse the BA through the Ao cannula. The BA loop was perfused with an oxygenated gas mixture (CO2 5%, O2 95%). PA perfusion flow rate was gradually increased up to 30 percent of cardiac output over a 40-minute period and maintained for the duration of perfusion. BA perfusion pressure was steadily increased to approximately 60 mmHg based on normal BA pressure using a preclinical animal model and similarly maintained throughout perfusion. Negative-pressure ventilation as described above was then started with a pressure gradient of 12-14 mmHg and a respiratory rate of 12 breaths per minute. Perfusate was warmed to 37° C. over a 15-minute period.

Continuous physiological measurement of the lungs was recorded during EVLP, including pulmonary vascular resistance, airway pressure, and lung compliance. Oxygenation was determined by PaO2/FiO2 (P/F) ratio based on outflow pO2. Blood gas and electrolyte values were measured using iSTAT (Abbott Point of Care, Princeton, NJ) and lactate by Lactate Plus (Nova Biomedical GmbH, Germany).

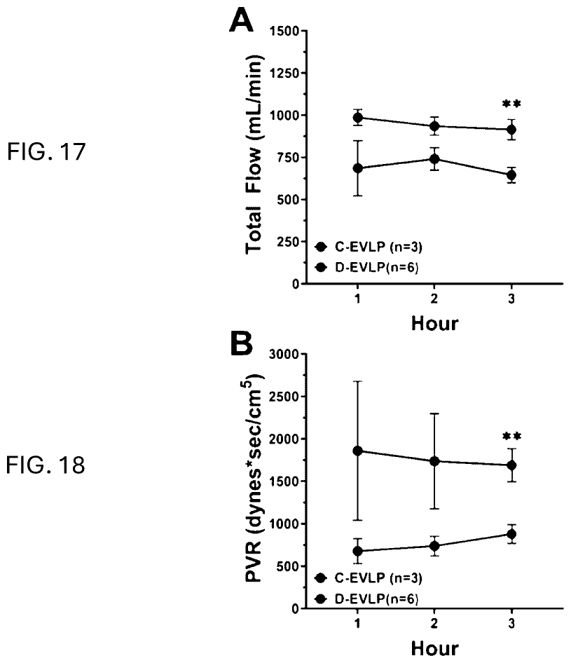

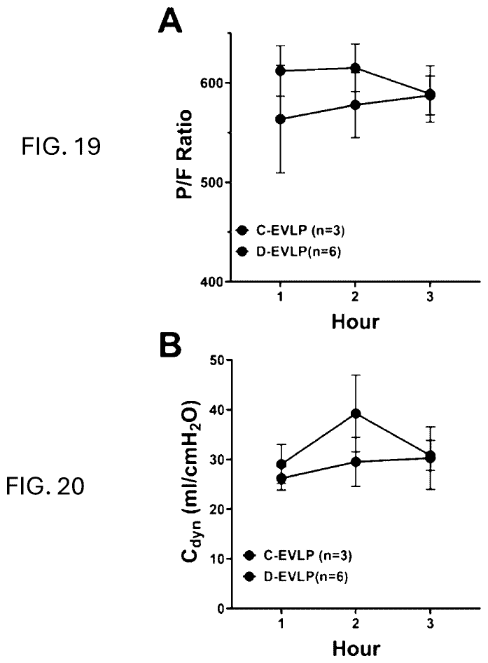

Measured ventilation data and chemical assay data for the test is shown in FIGS. 17-20. Total perfusion flow, representing the rate of perfusate outflow from the lung grafts, is shown in FIG. 17. PVR, which measures the resistance to blood flow in the pulmonary circulation, is shown in FIG. 18. P/F ratio is a reliable indicator of the lung's ability to oxygenate the body. Test data is shown in FIG. 19. CDYN, described above, is shown in FIG. 20.

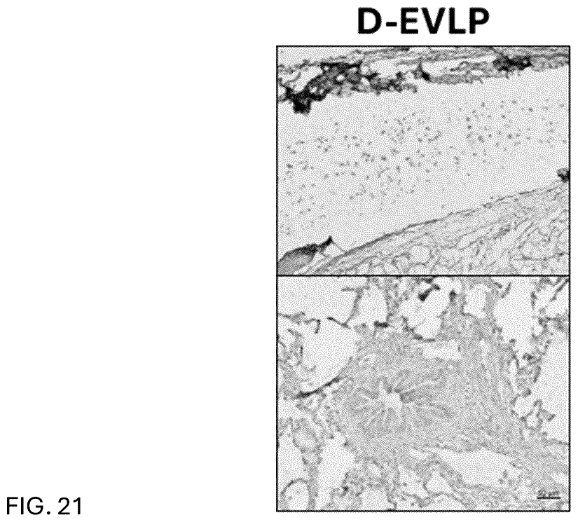

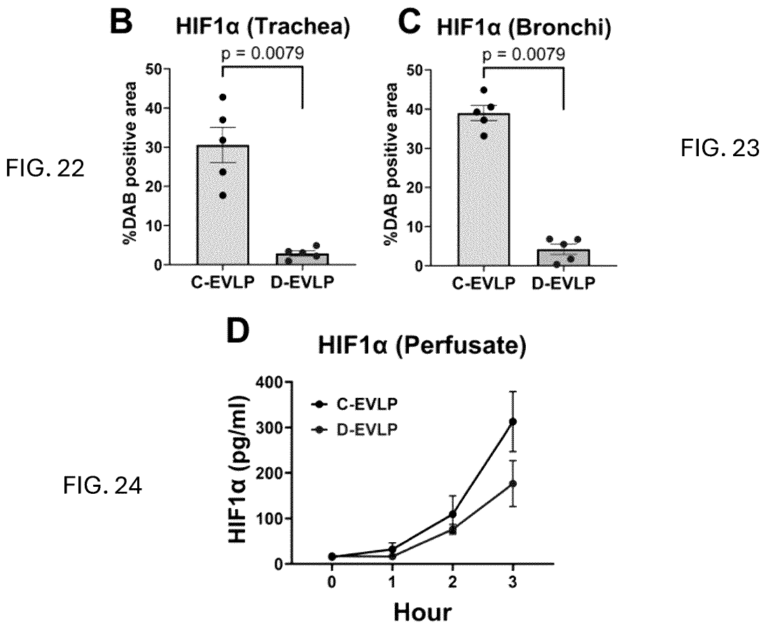

Hypoxia in the central and peripheral airway were determined by HIF1α expression in trachea and bronchi. IHC staining of the carinal biopsy showed reduction of in HIF1α expression in D-EVLP lungs (FIG. 21; trachea shown in the upper half and bronchi shown in the lower half). As shown in FIG. 22, the DAB positive area in trachea was quantified. FIG. 23 shows the DAB positive area in bronchi. HIF1α in D-EVLP perfusate is shown in FIG. 24 Collectively, these results indicate BA flow effectively reduced ischemia in the central airways and more distal bronchioles.

The apparatus described herein will maintain the viability and functionality of the lung, following removal from the donor or in preparation for surgical procedures.

The foregoing has described apparatus and methods for ex vivo lung preservation. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. An apparatus for perfusing a lung, comprising:
an enclosure configured to provide physical protection to a lung; and
a first fluid flow loop extending from an outlet connection of the enclosure to an inlet connection of the enclosure, the first fluid flow loop including a pump, an oxygenator, and a waveform generator;
a negative pressure ventilation apparatus configured to force respiration of the lung through cyclic changes of gas pressure between the lung and the enclosure;
at least one sensor operable to sense a parameter of a perfusate flowing within the first fluid flow loop and generate a signal representative thereof; and
a control and monitoring unit configured to receive the signal from the at least one sensor and adjust the parameter in response thereto.

2. The apparatus of claim 1, wherein the negative pressure ventilation apparatus includes:
an exhalation valve coupled to the enclosure; and
an inhalation valve coupled to the enclosure, the inhalation valve coupled with a vacuum pump.

3. The apparatus of claim 2, further comprising a ventilation controller configured operable to selectively open and close the inhalation and exhalation valves while the vacuum pump is operating in order to force respiration of the lung.

4. The apparatus of claim 1, further comprising a positive pressure apparatus configured to be coupled to the trachea of the lungs, wherein the positive pressure apparatus is configured to supply at least one of: room air and mixture of gases at a selected pressure.

5. The apparatus of claim 1, further comprising a second fluid loop, wherein one of the fluid loops is configured to supply fluid to the pulmonary artery and the other of the fluid loops is configured to supply fluid to the bronchial artery.

6. The apparatus of claim 1, wherein the enclosure is provided internally with a flexible hammock configured to support the lung within the enclosure.

7. The apparatus of claim 1, wherein the enclosure is configured to support a pair of lungs.

8. The apparatus of claim 1, further including a dialysis unit in fluid flow communication with the fluid loop.

9. A method of perfusing a lung, comprising:
placing the lung in an enclosure configured to provide physical protection to an organ;
coupling the lung to a fluid flow loop including a pump, an oxygenator, a waveform generator, and a negative pressure ventilation apparatus;
using the pump to circulate perfusion fluid through the fluid flow loop;
using the oxygenator to introduce oxygen into the perfusion fluid;
using the negative pressure ventilation apparatus to force respiration of the lung by applying cyclic changes of gas pressure between the lung and the enclosure; and
and
using the waveform generator to impress a preselected waveform profile upon the fluid flow in the fluid loop.

10. The method of claim 9, wherein the negative pressure ventilation apparatus includes:
an exhalation valve coupled to the enclosure; and
an inhalation valve coupled to the enclosure, the inhalation valve coupled with a vacuum pump.

11. The method of claim 10, further comprising using a ventilation controller to selectively open and close the inhalation and exhalation valves while the vacuum pump is operating in order to force respiration of the lung.

12. The method of claim 9, further comprising coupling a positive pressure apparatus to the trachea of the lungs, wherein the positive pressure apparatus is supplies at least one of: room air and mixture of gases at a selected pressure.

13. The method of claim 9, further comprising providing a second fluid loop, wherein one of the fluid loops supplies fluid to the pulmonary artery and the other of the fluid loops supplies fluid to the bronchial artery.

14. The method of claim 9, wherein the enclosure is provided internally with a flexible hammock configured to support the lung within the enclosure.

15. The apparatus of claim 9, wherein a pair of lungs are disposed in the enclosure.

16. The method of claim 9, further including using a dialysis unit to filter endogenous or exogenous material from the perfusion fluid.
